(19) United States
(12) Patent Application Publication
(10) Pub. No.: US 2014/0268879 A1
(43) Pub. Date: Sep. 18, 2014

(54) TRANSPARENT WAVEGUIDE DIFFUSER FOR LIGHTING AND METHODS OF MANUFACTURING TRANSPARENT WAVEGUIDE DIFFUSER

(71) Applicant: PANASONIC CORPORATION, Osaka (JP)

(72) Inventors: Yosuke MIZUYAMA, Newton, MA (US); Nathan HARRISON, Brookline, MA (US); Ayumu SATO, Osaka (JP)

(73) Assignee: PANASONIC CORPORATION, Osaka (JP)

(21) Appl. No.: 13/826,099

(22) Filed: Mar. 14, 2013

(51) Int. Cl. F21V 8/00

(52) U.S. Cl. CPC G02B 6/0043
USPC 362/618; 362/625; 427/163.2

(57) ABSTRACT

A waveguide light diffuser panel is disclosed that diffuses source lights and transmits ambient light. Conventional waveguide light diffusers diffuse all light and therefore provide a hazy outcome. In manufacturing a waveguide transparent diffuser, a printing method, such as inkjet printing, may be used. In this method, dot micro-lenses are formed on one side of a panel, which cover a portion of the panel in a staggered or random arrangement. The other side of the panel is coated with an anti-reflective material, or the shape of the panel may be concave. The dot shape is designed for efficient reflection of the incident light, as opposed to conventional hazy diffusers in which the reflection efficiency is low. High reflection efficiency in this case compensates for the reduced dot coverage.

### BACKGROUND

1. Field of the Disclosure

The present invention generally relates to light waveguide diffusers for illuminating environments or objects and methods of manufacturing light waveguide diffusers.

2. Background Information

Light sources used for illumination typically require waveguides to transfer light from the light sources to diffusing points and diffusers to diffuse or to spread out or to scatter the light to produce soft light, which generally cast shadows with no edges or soft edges as opposed to sharp edges. For example, in photography, soft light is used to reduce visibility of wrinkles for people to achieve a more youthful look.

Typical diffusers are hazy in appearance, or the diffusers are opaque or non-transparent. That is, an observer cannot see objects clearly through a typical diffuser. Typical diffusers may include for example, ground glass diffusers, Teflon diffusers, holographic diffusers, opal glass diffusers, and greyed glass diffusers. Because such diffusers are not transparent, their presence in the view of observers may seem distracting and unpleasant. Additionally, typical diffusers may scatter significant amounts of light back toward the light source, and thus, efficiency of the light source is reduced when such typical diffusers are used.

FIG. 1 illustrates a conventional diffuser panel, which may be for example, a ground glass diffuser panel. Such conventional ground glass diffuser panels are isotropically diffusive and therefore look hazy and not transparent. As illustrated in FIG. 1, when light, generally with wavelength in the visible band, intersects the diffusive surface 12 of the diffuser panel 10, the uneven and rough texture of the diffusive surface causes the light to become scattered or diffused in nearly all directions, depending on the varying surface angles of the diffusive surface. Since light is diffused in nearly all directions, the diffuser is called isotropically diffusive. Thus, objects appear hazy and not clearly visible when viewed through such conventional ground glass diffusers, thus making the conventional ground glass diffusers appear opaque or non-transparent.

FIGS. 2A and 2B illustrate a conventional waveguide diffuser panel, which may be for example, a waveguide diffuser panel with inkjet dots regularly aligned thereon. Specifically, FIG. 2A illustrates a top view of a conventional waveguide diffuser panel, and FIG. 2B illustrates a side view of a conventional waveguide diffuser panel. As illustrated, a waveguide diffuser panel 10 includes an array of regularly aligned printed “dots” 15 used as a flexible light extraction feature. The dots 15 may be a mass of material that is added to the surface of the panel 10, and may vary is shape and size. For example the dots may be shaped, for example, a circles, ovals, curvilinear shapes, squares rectangles, triangles, polygonal shapes and irregular shapes. The dots 15 may also be about the same size or vary from one dot to another. The dots 15 may be printed upon the front, back or both front and back surfaces of the panel 10 to extract light input into the panel 10 by light sources 20, such as a light emitting diode (LED), which may also be transmitted through beam shaping optics 25.

FIGS. 3A and 3B illustrate a transparent waveguide diffuser panel, which may be for example, a waveguide diffuser panel with dots sparsely or randomly aligned thereon. Specifically, FIG. 3A illustrates a top view of a transparent waveguide diffuser panel, and FIG. 3B illustrates a side view of a transparent waveguide diffuser panel. As illustrated, a waveguide diffuser panel 10 includes an array of sparsely aligned printed “dots” 15 used as a flexible light extraction feature. The dots 15 may be a mass of material that is added to the surface of the panel 10, and may vary is shape and size. For example the dots may be shaped, for example, as circles, ovals, curvilinear shapes, squares rectangles, triangles, polygonal shapes and irregular shapes. The dots 15 may also be about the same size or vary from one dot to another. The dots 15 may be printed upon the front, back or both front and back surfaces of the panel 10 to extract light input into the panel 10 by light sources 20, such as an LED, which may be transmitted through beam shaping optics 25. Through choices of materials, printing, and patterns, the lit and unlit properties of the panel 10 can be largely independently controlled. For example, large dots 15 may be used to limit the transmission through the panel 10 when the light sources 20 are dimmed or unlit. Similarly, a high concentration of smaller dots 15 can limit the transmission through the panel 10 when the light sources 20 are dimmed or unlit. The large or small dots may comprise, for example, diffusive particles or opaque materials, and be configured thicker or with a higher density to limit light transmission through the panel. In some embodiments, a low concentration of smaller dots 15 may be used to allow transmission through the panel 10 when the light sources 20 are dimmed or unlit.

In one example, the dots 15 may be printed onto the panel 10 by an ink jet printer, screen printing techniques, or any other ink printer. The dots may also be rolled, splattered, or sprayed onto the panel 10. The dots in any of the embodiments described herein can be formed by any of these processes, unless specifically stated otherwise.

### SUMMARY OF THE DISCLOSURE

The present disclosure, through one or more of its various aspects, embodiments, and/or specific features or sub-components, provides various device, apparatus, or structures that can achieve the transparent waveguide diffuser, as well as method that can be used to manufacture the transparent waveguide diffuser.

In one embodiment of the disclosure, there is a waveguide light diffuser panel coupled to a light source, including a first surface that is of low reflection to a plurality of wavelengths of light; and a second surface having diffusive dots, wherein visible light from the light source is transmitted through the waveguide light diffuser panel, and at least a portion of the visible light from the light source is reflected from the inkjet dots on the second surface and transmitted through the first surface.

In one aspect of the disclosure, the diffusive dots are one of micro-lenses, micro-dots and micro-bumps formed by one of molding, embossing, screen printing, and inkjet printing.

In another aspect of the disclosure, the diffusive dots cover 20-50% of the waveguide diffuser panel surface

In still another aspect of the disclosure, the diffusive dots are distributed on the waveguide light diffuser panel in a grid array in one of a sparse, staggered, random, semi-random, and interleaved arrangement.

In yet one aspect of the disclosure, a period of the diffusive dots is enlarged or reduced.

In yet another aspect of the disclosure, shape of the dots is configurable into variable designs.

In one more aspect of the disclosure, the waveguide light diffuser panel is transparent.

In still another aspect of the disclosure, the waveguide light source is an LED.

In one aspect of the disclosure, the first surface is coated with a single or multi-layer anti-reflective coating.

In another aspect of the disclosure, the waveguide light diffuser panel has a concave shape causing divergent reflection of the visible light.

In yet one more aspect of the disclosure, the light source is mounted on at least one location on an edge of the waveguide light diffuser panel and configured to transmit the plurality of wavelengths of light into the waveguide light diffuser panel.

In another embodiment of the disclosure, there is a waveguide light diffuser panel coupled to a light source, including a first surface that has a concave shape causing divergent reflection of visible light; and a second surface having diffusive dots, wherein the visible light from the light source is transmitted through the waveguide light diffuser panel, and at least a portion of the visible light from the light source is reflected from the inkjet dots on the second surface and divergently transmitted through the second surface after at least partially reflecting off of the first surface.

In still another embodiment of the disclosure, there is a method of manufacturing a waveguide light diffusing panel coupled to a light source, including preparing a first surface that is of low reflection to a plurality of wavelengths of light; and preparing a second surface having diffusive dots, wherein visible light from the light source is configured to be transmitted through the waveguide light diffuser panel, and at least a portion of the visible light from the light source is configured to be reflected from the inkjet dots on the second surface and transmitted through the first surface.

In yet another embodiment of the disclosure, there is a light fixture having a waveguide diffusing panel coupled to a light source, including the light waveguide diffusing panel according to the first described embodiment.

### BRIEF DESCRIPTION OF THE DRAWINGS

The present invention is further described in the detailed description which follows, in reference to the noted plurality of drawings, by way of non-limiting examples of preferred embodiments of the present invention, in which like characters represent like elements throughout the several views of the drawings.

FIG. 1 illustrates an exemplary embodiment of a conventional waveguide light diffuser panel.

FIG. 2A illustrates a top view of conventional waveguide light diffuser panel with printed dots.

FIG. 2B illustrates a side view of a conventional waveguide light diffuser panel with printed dots.

FIG. 3A illustrates a top view of a transparent waveguide light diffuser panel with printed dots.

FIG. 3B illustrates a side view of a transparent waveguide light diffuser panel with printed dots.

FIG. 4 illustrates an exemplary embodiment of light propagating through a waveguide diffuser panel.

FIG. 5A illustrates an exemplary embodiment of light propagating through a waveguide diffuser panel having an anti-reflective coating.

FIG. 5B illustrates an exemplary embodiment of light propagating through a waveguide diffuser panel having nano-patterning.

FIG. 6A illustrates an exemplary embodiment of a waveguide diffuser panel having a nano-pattern applied in a sparse or staggered manner.

FIG. 6B illustrates an exemplary embodiment of a waveguide diffuser panel having a nano-pattern applied in a random or semi-random manner.

FIG. 7 illustrates an exemplary overlapping Talbot image.

FIG. 8 illustrates an exemplary waveguide diffuser panel which has a concave shape.

FIG. 9 illustrates an exemplary flow diagram in accordance with one embodiment of the disclosure.

### DETAILED DESCRIPTION

The present disclosure, through one or more of its various aspects, embodiments and/or specific features or sub-components, is thus intended to bring out one or more of the advantages as specifically noted below.

A transparent waveguide light diffuser panel is disclosed in which the panel diffuses source lights and transmits ambient light. Conventional waveguide light diffusers diffuse all light and therefore provide a hazy outcome. In manufacturing a transparent waveguide diffuser, a printing method, such as inkjet printing, screen printing techniques or any other ink printing, may be used. In this method, micro-lenses in the form of dots are printed on one side of a panel, which micro-lenses cover at least a portion of the panel in a variety of arrangements. For example, the dots may cover between 20%-50% of the panel (it is appreciated that the dot coverage range is not limited to 20%-50 and may extend beyond these ranges in either direction), and arranged in a sparse, staggered, random, semi-random, interleaved or any other pattern. The other side of the panel is coated with an anti-reflective material (or multiple layers of material), or the shape of the panel may be formed to diffuse, converge or diverge light. For example, the panel may be in a concave shape. However, the disclosure is not limited to a concave shape as understood by the skilled artisan. The dot shape and size is designed for efficient reflection of the incident light, as opposed to conventional hazy diffusers in which the reflection efficiency is low. High reflection efficiency in this case compensates for the reduced dot coverage.

Manufacturing using inkjet based printing is typically based on a grid positioning method. Using this method, inkjet dots are deposited on an imaginary grid on a panel. Depositing dots using this method introduces a Talbot image, which is a periodic image of the micro-lenses formed by the dots. Unfortunately, the Talbot image disturbs the appearance quality of the light.

FIG. 4 illustrates a waveguide light diffuser panel having inkjet dots deposited on one side of a panel. When light A is generated from a light source 20 (such as an LED), it is reflected off of the dots 15 onto a surface of the panel 10 and forms a reflection B, known as a Frensel reflection. The reflection occurs when there is no anti-reflection material to prevent the light from reflecting off of the panel. Ultimately, the reflection becomes a light source that creates a virtual image 35, known as the Talbot image. The Talbot image appears as a periodic and discrete image of dots in a pattern similar to those arranged on the panel 10 from which the light was reflected. This image imparts an unwanted luminance to any viewer V in the line of sight of the reflection B. Accordingly, a transparent waveguide diffuser that can provide higher efficiency of lighting and a more desirable and transparent view is preferred. However, when manufacturing using an inkjet method, grid positioning is used to apply the dots (unless a stylus method is used). It is the arrangement of the dots on the panel in a grid-like manner that results in an undesirable Talbot image, as described above.

FIGS. 5A and 5B illustrate a waveguide light diffuser panel using inkjet dots that has a coating on one side of the panel. The waveguide light diffuser panel 10 illustrated in the Figures reduce or eliminate the unwanted Talbot image using one of several techniques, as described below. In order to reduce or eliminate the Talbot image, one of the following techniques may be used: (a) reduce or eliminate the light source, and/or (b) make the light source difficult to view. In the illustrated embodiment, inkjet dots 15 are deposited on a back-side of panel 10. As illustrated, the dots 15 are sparsely deposited on the back-side of the panel 10, and a material is applied on the front-side of panel 10. A light source 20 propagates through the panel 10, and reflects off of the inkjet dots 15 toward the front-side of panel 10 (depicted as line A). With the coating on the front-side of the panel 10, the reflection of the propagating light off of the front-side of panel 10 is reduced or eliminated. The reflection is reduced or eliminated owing to the presence of the material or coating, such that the intensity of the Talbot image is reduced accordingly. The material or coating in this described embodiment may be an anti-reflection (AR) material or coating as a single or multi-layer coating, such as formed by nano-patterning, but not limited to such an embodiment. It is appreciated that any number of types of material or coating may be used, and the anti-reflective material or coating may be applied using any technique known in the art and explained further below.

The waveguide light diffuser panel 10 may be integrated with a light emitting element or light source 20 on one edge of the waveguide diffuser panel 10. The light source 20 may be for example, a LED (light emitting diode), laser diode and SLD (super luminescent diode), or coupling optics such as collection lens, collimator, and beam shaper, etc. which transmit light generated from a source of light. The light source 20 may be mounted or bonded on one edge of the waveguide light diffuser panel 10, for example by mechanical mounting structures, chemical adhesives, heating, or a combination of such mounting methods. The light source 20 may be, for example, designed to direct light of one or more visible wavelengths into the waveguide light diffuser panel 10 from one edge, at one or more oblique angles relative to the plane of the waveguide light diffuser panel 10, or at one or more angles that are greater than the total internal reflection (TIR) angle or critical angle of the waveguide light diffuser panel 10.

In this configuration, the light transmitted by the light source 20 into the waveguide light diffuser panel 10 will be waveguided and diffused from generally the entire surface of waveguide light diffuser panel 10, as noted above, to illuminate objects on both sides of the panel via bi-directional illumination. As also noted above, the illuminated objects would be clearly visible when viewed through the waveguide light diffuser panel 10. This provides a transparent waveguide light diffuser that can provide higher efficiency of lighting and a more pleasant transparent view.

As explained, the light source resulting in the Talbot image is the reflection of light from the front-side of the waveguide light diffuser panel 10. This reflection may be reduced or eliminated, for example, using a regular anti-reflective (AR) coating or material. The following are examples of coating techniques that may be applied to the front-side of the panel.

(1) Regular single film AR coating:

A coating with a refractive index of in, where √n is the panel index. For example, a panel formed of acrylic has an index of about 1.51 for most visible light range. Accordingly, the index of the AR coating material for the acrylic panel should be √1.51≈1.23.

(2) Multi-layer coating: Multiple coatings are used to coat the panel. Exemplary coatings include SiO₂, TiO₂ and ZrO₂. It is appreciated that the coatings are not limited to the described embodiments, which are for exemplary purposes.

(3) Sub-wavelength periodic structure surface:

Instead of using a regular AR coating, the front surface of the panel 10 is embossed or imprinted with holes or bumps to avoid or significantly reduce reflection. The holes or bumps, in one embodiment, are sub-wavelength holes and bumps. That is, if the structure period is smaller than λ, where λ is the maximum wavelength of the light source (e.g. LED) spectrum, reflection does not occur for visible light.

FIGS. 6A and 6B illustrate exemplary dot pattern layouts on a waveguide light diffuser panel. As shown, the dots 15 are laid out in a grid pattern on a back-side of panel 10 to manipulate the original image source. Manipulation of the image source, as explained, will reduce or eliminate the resultant Talbot image that is formed therefrom. The image source may be manipulated using, for example, micro-lenses formed from the dots. In particular, the image source may be manipulated by (a) enlarging the period of the dots (b) reducing the period of the dots, or (c) forming local curvatures on the front side of the panel. FIG. 6A illustrates one exemplary embodiment in which the dots 15 are sparsely or staggered distributed on the panel 10. FIG. 6B illustrates another exemplary embodiment in which the dots 15 are randomly or semi-randomly distributed on the panel 15. In either case, the resulting Talbot image appears as an array of dots having a period proportional to the dot period.

When the dot period is small, the resultant Talbot image period is also small. Accordingly, by making the Talbot image small, the individual dot images overlap with each other and eventually become homogenized to create a uniform Talbot image (as illustrated, for example, in FIG. 7). This improves the problems associated with having a discrete particulate image. Since the minimum period of the Talbot image is determined by the minimum period of dots, a smaller grid period is defined than in a conventional grid period. For example, a conventional grid period is 339 um=75 dpi, whereas a smaller grid period of 42.3 um=600 dpi or 21.2 um=1200 dpi is used in the disclosed embodiments. Of course, the grid period is exemplary and may be modified as readily understood by the skilled artisan. To maintain transparency of the waveguide diffuser panel while having a finer period and uniform illumination, the dots may be aligned in a sparse distribution, staggered distribution, interleaved distribution, random or semi-random distribution.

FIG. 8 illustrates an exemplary dot pattern layout on a waveguide light diffuser panel with a shaped surface. As shown, the dots 15 are laid out in a grid pattern on a back-side of waveguide light diffuser panel 10 to manipulate the original image source. Manipulation of the image source, as explained, will reduce or eliminate the resultant Talbot image that is formed therefrom. As illustrated in the Figure, the Talbot image period is reduced or eliminated because the light source is divergent as a result of the curvature of the panel. The greater the surface curvature the more the Talbot image overlaps and becomes homogenized. In the illustrated embodiment, the curved surface is concave and is shaped on the front-side of the waveguide light diffuser panel 10. However, the shape of the surface is not limited to the disclosed embodiment. Any shape may be used to diffuse, converge or diverge light as readily understood by the skilled artisan.

FIG. 9 illustrates an exemplary flow diagram in accordance with one embodiment of the invention. More specifically, the flow diagram illustrates a method of waveguiding and diffusing light using a waveguide light diffuser panel having a first surface that is diffusive of a plurality of wavelengths of light and a second surface with nano-patterning. In a step 1, the waveguide material is prepared to guide the light waves emitted from the light source, such as an LED. Emboss a nano-pattern or laminate a pre-nano-printed sheet (coating) on one side of the waveguide material. On the other side of the material, injet diffusing dots are printed, in step 2. Then, the coupling optics are attached to the waveguide in step 4 and the light source(s) is attached in step 5.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. In this regard, no attempt is made to show structural details of the present invention in more detail than is necessary for the fundamental understanding of the present invention. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A waveguide light diffuser panel coupled to a light source, comprising:
a first surface that is of low reflection to a plurality of wavelengths of light; and
a second surface having diffusive dots,
wherein visible light from the light source is transmitted through the waveguide light diffuser panel, and at least a portion of the visible light from the light source is reflected from the inkjet dots on the second surface and transmitted through the first surface.

2. The waveguide light diffuser panel according to claim 1, wherein the diffusive dots are one of micro-lenses, micro-dots and micro-bumps formed by one of molding, embossing, screen printing, and inkjet printing.

3. The waveguide light diffuser panel according to claim 2, wherein the diffusive dots cover 20-50% of the waveguide diffuser panel surface

4. The waveguide light diffuser panel according to claim 2, wherein the diffusive dots are distributed on the waveguide light diffuser panel in a grid array in one of a sparse, staggered, random, semi-random, and interleaved arrangement.

5. The waveguide light diffuser panel according to claim 2, wherein a period of the diffusive dots is enlarged or reduced.

6. The waveguide light diffuser panel according to claim 2, wherein the shape of the dots is configurable into variable designs.

7. The waveguide light diffuser panel according to claim 1, wherein the waveguide light diffuser panel is transparent.

8. The waveguide light diffuser panel according to claim 1, wherein the waveguide light source is an LED.

9. The waveguide light diffuser panel according to claim 1, wherein the first surface is coated with a single or multi-layer anti-reflective coating.

10. The waveguide light diffuser panel according to claim 1, wherein the waveguide light diffuser panel has a concave shape causing divergent reflection of the visible light.

11. The waveguide light diffuser panel according to claim 1, wherein the light source is mounted on at least one location on an edge of the waveguide light diffuser panel and configured to transmit the plurality of wavelengths of light into the waveguide light diffuser panel.

12. A waveguide light diffuser panel coupled to a light source, comprising:
a first surface that has a concave shape causing divergent reflection of visible light; and
a second surface having diffusive dots,
wherein the visible light from the light source is transmitted through the waveguide light diffuser panel, and at least a portion of the visible light from the light source is reflected from the inkjet dots on the second surface and divergently transmitted through the second surface after at least partially reflecting off of the first surface.

13. The waveguide light diffuser panel according to claim 12, wherein the diffusive dots are one of micro-lenses, micro-dots and micro-bumps formed by one of molding, embossing, screen printing, and inkjet printing.

14. The waveguide light diffuser panel according to claim 13, wherein the diffusive dots cover 20-50% of the waveguide diffuser panel surface

15. The waveguide light diffuser panel according to claim 13, wherein the diffusive dots are distributed on the waveguide light diffuser panel in a grid array in one of a sparse, staggered, random, semi-random, and interleaved arrangement.

16. The waveguide light diffuser panel according to claim 13, wherein a period of the diffusive dots is enlarged or reduced.

17. The waveguide light diffuser panel according to claim 13, wherein the shape of the dots is configurable into variable designs.

18. The waveguide light diffuser panel according to claim 12, wherein the waveguide light diffuser panel is transparent.

19. The waveguide light diffuser panel according to claim 12, wherein the waveguide light source is an LED.

20. The waveguide light diffuser panel according to claim 12, wherein the first surface is coated with a single or multi-layer anti-reflective coating.

21. The waveguide light diffuser panel according to claim 12, wherein the light source is mounted on at least one location on an edge of the waveguide light diffuser panel and configured to transmit the plurality of wavelengths of light into the waveguide light diffuser panel.

22. A method of manufacturing a waveguide light diffusing panel coupled to a light source, comprising:
preparing a first surface that is of low reflection to a plurality of wavelengths of light; and
preparing a second surface having diffusive dots,
wherein visible light from the light source is configured to be transmitted through the waveguide light diffuser panel, and at least a portion of the visible light from the light source is configured to be reflected from the inkjet dots on the second surface and transmitted through the first surface.

23. A light fixture having a waveguide diffusing panel coupled to a light source, comprising the light waveguide diffusing panel according to claim 1.
